(19) United States
(12) Patent Application Publication
(10) Pub. No.: US 2002/0123353 A1
(43) Pub. Date: Sep. 5, 2002

(54) Tracking system and method employing cellular network control channels

(76) Inventor: Paul-Andre Savoie, Laval (CA)

Correspondence Address: PEARNE & GORDON LLP, 526 SUPERIOR AVENUE EAST, SUITE 1200, CLEVELAND, OH, 44114-1484, US

(21) Appl. No.: 10/067,115

(22) Filed: Feb. 4, 2002

Related U.S. Application Data
(60) Provisional application No. 60/265,606, filed on Feb. 2, 2001.

(51) Int. Cl. H04Q 7/20

(52) U.S. Cl. 455/456; 455/461

(57) ABSTRACT

A tracking system and method employing cellular network control channels. The system, leveraging existing Roamer Record Exchange Systems (RRES), comprises a cellular transceiver installed in a tracking target and a central server for paging the installed cellular transceiver to enter into a tracking mode over a cellular network control channel and collecting tracking mode information provided through RRES to map information such as Cell Site ID and Sector for use as reference points for the tracking of the tracking target. The method, leveraging existing Roamer Record Exchange Systems (RRES), includes the steps of installing a cellular transceiver in a tracking target, and paging the installed cellular transceiver over a cellular network control channel to enter into a tracking mode to identify, from information provided through the RRES, one or more cell sites located near the tracking target so as to enable the tracking of the tracking target.

### CROSS-REFERENCE TO RELATED APPLICATION

This application claims the benefit of U.S. Provisional Patent Application Serial No. 60/265,606 filed Feb. 2, 2001.

### FIELD OF THE INVENTION

The present invention relates generally to tracking systems, and more particularly to a tracking system and method employing cellular network control channels.

### BACKGROUND OF THE INVENTION

In recent years, tracking systems that have long been envisioned have become feasible due to the proliferation of cellular networks. Tracking is now being performed for such things as pallets, loads, containers and vehicles.

However, existing tracking systems that use cellular networks, such as circuit switched voice channel tracking, are inherently intrusive to cellular network infrastructure. Furthermore, these systems are not responsive enough to accurately track fleet vehicles, or successfully locate a stolen vehicle; something highly desirable in the insurance industry.

More recently to overcome these limitations, systems have been developed that utilize the Global Positioning System (GPS); however GPS doesn't work well indoors and is expensive. Therefore, what is needed is an inexpensive tracking system with ability to track moving objects in real time, such as vehicles, and that is not intrusive to cellular network infrastructure and works well indoors.

For the foregoing reasons, there is a need for an improved tracking system and method.

### SUMMARY OF THE INVENTION

The present invention is directed to a tracking system and method employing cellular network control channels. The system, leveraging existing Roamer Record Exchange Systems (RRES), includes a cellular transceiver installed in a tracking target and a central server for paging the installed cellular transceiver to enter into a tracking mode over a cellular network control channel and collecting tracking mode information provided through RRES to map information such as Cell Site ID and Sector for use as reference points for the tracking of the tracking target.

In an aspect of the present invention, the system further includes a chase vehicle deployed to a tracked location to enable the interception of a stolen vehicle. The chase vehicle includes a tracking module having a Doppler direction finder for finding the direction of the stolen vehicle's cellular transceiver, a tracking radio linked to the Doppler direction finder; and an updating radio set to periodically update the chase vehicle's position in one direction, and update the control channel frequency, used by the tracking mode and tuned into the tracker module, in the other direction.

The method, leveraging existing Roamer Record Exchange Systems (RRES), includes the steps of installing a cellular transceiver in a tracking target, and paging the installed cellular transceiver over a cellular network control channel to enter into a tracking mode to identify, from information provided through the RRES, one or more cell sites located near the tracking target so as to enable the tracking of the tracking target.

In an aspect of the present invention, the method further includes the step of deploying a chase vehicle to a tracked location to enable the interception of a stolen vehicle. The chase vehicle includes a tracking module having a Doppler direction finder for finding the direction of the stolen vehicle's cellular transceiver, a tracking radio linked to the Doppler direction finder; and an updating radio set to periodically update the chase vehicle's position in one direction, and update the control channel frequency, used by the tracking mode and tuned into the tracker module, in the other direction.

In an aspect of the present invention, the chase vehicle is further equipped with a Global Positioning System (GPS) receiver for determining its own location with respect to one or more cell sites identified as being close to the target to enable the chase vehicle to more quickly travel to an area determined by the identified cell sites. In a further aspect of the present invention, the invention further comprises means for using a determined unusable control channel to transmit tracking information so as to further minimize drain on cellular network resources.

The invention is simple to implement and offers advantages over solely GPS systems in that it works indoors and reduces the hardware costs by as much as 80%.

Other aspects and features of the present invention will become apparent to those ordinarily skilled in the art upon review of the following description of specific embodiments of the invention in conjunction with the accompanying figures.

### BRIEF DESCRIPTION OF THE DRAWINGS

These and other features, aspects, and advantages of the present invention will become better understood with regard to the following description, appended claims, and accompanying drawings where:

FIG. 1 is an overview of a tracking system employing cellular network control channels according to an embodiment of the present invention; and

FIG. 2 illustrates a tracking method employing cellular network control channels according to an embodiment of the present invention.

### DETAILED DESCRIPTION OF THE PRESENTLY PREFERRED EMBODIMENT

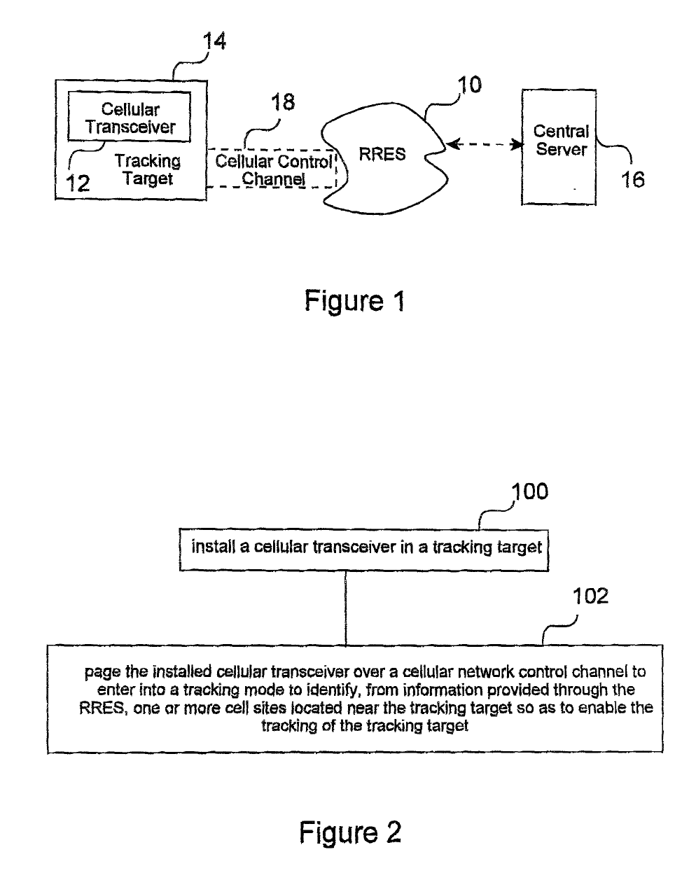

The present invention is directed to a tracking system and method employing cellular network control channels. As illustrated in FIG. 1, the system, leveraging existing Roamer Record Exchange Systems (RRES) 10, includes a cellular transceiver 12 installed in a tracking target 14 and a central server 16 for paging the installed cellular transceiver 12 to enter into a tracking mode over a cellular network control channel 18 and collecting tracking mode information provided through RRES 10 to map information such as Cell Site ID and Sector for use as reference points for the tracking of the tracking target 14.

In an embodiment of the present invention, the system further includes a chase vehicle deployed to a tracked location to enable the interception of a stolen vehicle. The chase vehicle includes a tracking module having a Doppler direction finder for finding the direction of the stolen vehicle's cellular transceiver, a tracking radio linked to the Doppler direction finder; and an updating radio set to periodically update the chase vehicle's position in one direction, and update the control channel frequency, used by the tracking mode and tuned into the tracker module, in the other direction.

As illustrated in FIG. 2, the method, leveraging existing Roamer Record Exchange Systems (RRES), includes the steps of installing a cellular transceiver in a tracking target 100, and paging the installed cellular transceiver over a cellular network control channel to enter into a tracking mode to identify, from information provided through the RRES, one or more cell sites located near the tracking target so as to enable the tracking of the tracking target 102.

In an embodiment of the present invention, the method further includes the step of deploying a chase vehicle to a tracked location to enable the interception of a stolen vehicle 104. The chase vehicle includes a tracking module having a Doppler direction finder for finding the direction of the stolen vehicle's cellular transceiver, a tracking radio linked to the Doppler direction finder; and an updating radio set to periodically update the chase vehicle's position in one direction, and update the control channel frequency, used by the tracking mode and tuned into the tracker module, in the other direction.

A cellular transceiver is installed in a target object requiring tracking, such as a vehicle. The cellular transceiver operates on a continuous standby mode so as to remain constantly accessible to the system. When tracking is initiated, the cellular transceiver is switched to an active mode. The general location of the tracking target can then be determined by paging the cellular transceiver installed in the tracking target to identify one or more cell sites located near the tracking target.

In an embodiment of the present invention, this information can then be relayed to a chase vehicle, which makes use of a radio direction finder to obtain an accurate bearing on the location of the tracking target.

In an embodiment of the present invention, the chase vehicle is further equipped with a Global Positioning System (GPS) receiver for determining its own location with respect to the one or more cell sites identified as being close to the tracking target so that the chase vehicle can more quickly travel to the area determined by the identified cell sites.

The system can operate on either an Advanced Mobile Phone System (AMPS) network or a Global System for Mobile Communication (GSM) network. The system leverages existing Time Division Multiple Access (TDMA)/AMPS functionality on AMPS networks, and Short Message Service (SMS) functionality on GSM networks.

Tracking functions are embedded within the cellular transceiver, which when remotely activated via a conventional TDMA/AMPS page, enable a TDMA/AMPS-enabled device to continuously transmit its Mobile Identification Number (MIN) and Electronic Serial Number (ESN) via a forced registration on a local control channel. This enables a chase vehicle with tracking equipment to get within relatively close range and home in on a signal in order to track down the cellular transceiver, and thus the tracking target.

In an example of an IS-41 (A) TDMA/AMPS environment each carrier, A and B, has 27 control channels spaced 300 MHz apart with a Forward Control Channel (FOCC) and Reverse Control Channel (RECC) direction spread of 45 KHz apart. These frequencies are repeatedly reused throughout the entire North American network.

The cellular transceiver remains in an idle state on the TDMA/AMPS enabled network until its tracking functionality is initiated upon receiving a conventional TDMA/AMPS page. The cellular transceiver then identifies all FOCC's in its area, and selects the appropriate one to operate on based on predetermined criteria.

Once the cellular transceiver is paged to enter into the tracking mode, it returns a TDMA/AMPS message containing the chosen control channel frequency encoded in the message. This response is location traceable via the use of a Roamer Record Exchange System (RRES) that sends completed Call Detail Records (CDR) from a serving carrier to a home carrier in near real-time, to offer wider visibility of a wireless carrier's numbers while their subscribers are roaming.

Upon collection of CDRs, the RRES creates a record and routes the call's information back to a central server based on the Numbering Plan Area/Network Numbering Exchange (NPA/NXX) information associated with the call. The RRES record includes fields such as MIN, ESN, call direction, dialed digits, switch SID, cell site ID and sector, switch number, channel numbers, feature flags such as call forwarding and three way calling, call duration, start of call date/time, and end of call date/time.

Existing cellular networks interpret roaming data packets on the fly and log them to their own CDR databases for billing purposes. The system maps Cell Site ID and Sector information for use as reference points for an approximate radio location. In an embodiment of the present invention, the system further includes an imaging module that is Java-based, light, signed, feature-rich browser-based Internet mapping suite comparable to off-the-shelf Geographic Information Systems (GIS).

Because the imaging module is vector based, and not bitmap based, the imaging module enables user-selectable client-side data caching, creating quicker response times for frequent system users.

Furthermore, the imaging module client includes a 500 ms connection ping, ensuring the information is always bi-directionally updated in real time.

The imaging module client includes a location based person-to-person, real-time web-to-wireless communications interface.

Once the general area of the cellular transceiver has been determined by analyzing the CDR data, a chase vehicle equipped with a tracker module is deployed to the area. The tracker module includes a regular 800 MHz radio linked to a Doppler direction finder, a GPS receiver, and a Microburst radio set to periodically update the chase vehicle's position in one wireless direction and update the control channel frequency tuned into the tracker module in the other.

The central server automatically forwards and transmits inbound information from the cellular transceiver in the tracking mode via TDMA/AMPS to the tracker module in the chase vehicle. This enables real-time control channel frequency synchronization in the tracking mode between the tracker module and the cellular transceiver.

The driver of the chase vehicle then drives towards the RF-origin determined by the Doppler direction finding equipment. As the chase vehicle approaches, the signal strength will increase and therefore will enable a driver to quickly close in.

In an embodiment of the present invention, the weakest RECC or “URECC” is determined so as to further minimize any drain on network resources by using what would be a normally unusable control channel. A URECC is defined as the RECC of an FOCC that is received by the cellular transceiver at −110 db/m or worse and has no legible data.

In addition, the cellular transceiver must further have at least one FOCC with signal strength of −100 db/m or better to enable the tracking mode. This precaution guards against a radio falsely determining a positive U-RECC because it has no antenna connected.

The selected frequency is then transmitted via a conventional TDMA/AMPS message to a central server where the message is decoded, and the weakest reverse control channel (U-RECC) is obtained. If no U-RECC is available, this information will be relayed via TDMA/AMPS as well.

The cellular transceiver registers for a period of 30 minutes as a normal AMPS device would, but is locked at a rapid +/−5 second interval, regardless of the Autonomous-Registration (AR) setting of the network. Because there is no active FOCC to worry about, neither the AR count nor the Busy-Idle Bit (BIB) indicator would be used to determine registration timing. The +/− 5-second interval separating registrations is caused by the time it takes to reverify that the U-RECC's FOCC is still an unassigned frequency. This reverification is critical in the case of a mobile cellular transceiver. If it is determined that the U-RECC no longer complies with the above criteria, and is thus considered a network usable frequency, the radio will fall back to finding an unusable control channel at which time the 30 minute clock is reset, otherwise this embodiment's mode will remain in effect for the balance of 30 minutes. If no unusable control channel exists, the system can then default to a usable channel.

During this time, the cellular transceiver is not listening to the active control channel of the network; it is merely transmitting, as would a beacon.

This operation has no negative impact on the network, since the frequency being used remains unused by either the network or any other wireless device in that area. In fact, the wireless network would never be aware of its presence.

At this point, once every five minutes the cellular transceiver will stop registering and listen to the active U-RECC's FOCC for 10 consecutive seconds to be certain the optimum U-RECC is being used. If the U-RECC remains the same, the cellular transceiver will continue registering, otherwise falling back to determining a new U-RECC.

In addition, once every 30 minutes, the cellular transceiver stops registering and returns to a normal TDMA/AMPS device setting, exiting the tracking mode altogether. It then transmits a message to the central server indicating that it has reverted to this mode of operation due to a timeout, and awaits a response. The central server will then automatically reply if a requirement to re-enter this mode is determined, thereby returning to searching for a U-RECC. If no response is received from the central server, the cellular transceiver will remain in its regular state on the TDMA/AMPS network, thereby assuring that the system doesn't “run away”.

The invention is simple to implement. The invention offers advantages over solely GPS systems in that it works indoors and reduces the hardware costs by as much as 80%. The invention causes minimal impact on cellular networks, either on voice channels or control channels.

Since tracking a stolen vehicle is only implemented after the theft of that vehicle, GPS is often inadequate due to its inherent indoor limitations where vehicles are often hidden from view. For this reason, the invention offers advantages over purely GPS systems in that it works for tracking targets that have gone indoors. The invention provides advantages over circuit-switched voice channel tracking systems currently in use, including increased transmission signal strength of about 3W vs. 0.6W, and reduced impact on the network. The invention is TDMA/AMPS network ready; data capable, bidirectional, and embeddable into existing applications. The invention provides reduced costs, greater reliability, expandability and is easier to maintain and operate.

Since all the other cellular network features are typically considered of a higher priority, the invention ensures that the system has no negative impact on a cellular network, so as to avoid impeding any existing wireless infrastructure functionality.

Although the present invention has been described in considerable detail with reference to certain preferred embodiments thereof, other versions are possible. Therefore, the spirit and scope of the appended claims should not be limited to the description of the preferred embodiments contained herein.

What is claimed is:

1. A tracking system employing cellular network control channels, leveraging existing Roamer Record Exchange Systems (RRES), the tracking system comprising:
a cellular transceiver installed in a tracking target; and
a central server for paging the installed cellular transceiver to enter into a tracking mode over a cellular network control channel, and collecting tracking mode information provided through RRES to map information such as Cell Site ID and Sector for use as reference points for the tracking of the tracking target.

2. The system according to claim 1, further includes a chase vehicle deployed to a tracked location to enable the interception of a stolen vehicle, the chase vehicle including a tracking module having:
a Doppler direction finder for finding the direction of the stolen vehicle's cellular transceiver;
a tracking radio linked to the Doppler direction finder; and
an updating radio set to periodically update the chase vehicle's position in one direction, and update the control channel frequency, used by the tracking mode and tuned into the tracker module, in the other direction.

3. The system according to claim 2, wherein the chase vehicle is further equipped with a Global Positioning System (GPS) receiver for determining its own location with respect to one or more cell sites identified as being close to the target to enable the chase vehicle to more quickly travel to an area determined by the identified cell sites.

4. The system according to claim 1, further comprising means for using a determined unusable control channel to transmit tracking information so as to further minimize drain on cellular network resources.

5. A tracking method employing cellular network control channels, leveraging existing Roamer Record Exchange Systems (RRES), the method comprising the steps of:
(i) installing a cellular transceiver in a tracking target; and
(ii) paging the installed cellular transceiver, over a cellular network control channel, to enter into a tracking mode to identify, from information provided through the RRES, one or more cell sites located near the tracking target so as to enable the tracking of the tracking target.

6. The method according to claim 5, further includes the step of deploying a chase vehicle to a tracked location to enable the interception of a stolen vehicle, the chase vehicle including a tracking module having:
a Doppler direction finder for finding the direction of the stolen vehicle's cellular transceiver;
a tracking radio linked to the Doppler direction finder; and
an updating radio set to periodically update the chase vehicle's position in one direction, and update the control channel frequency, used by the tracking mode and tuned into the tracker module, in the other direction.

7. The method according to claim 6, wherein the chase vehicle is further equipped with a Global Positioning System (GPS) receiver for determining its own location with respect to one or more cell sites identified as being close to the target to enable the chase vehicle to more quickly travel to an area determined by the identified cell sites.

8. The system according to claim 5, further comprising the step of using a determined unusable control channel to transmit tracking information so as to further minimize drain on cellular network resources.

9. A tracking system employing cellular network control channels, the system comprising:
means for installing a cellular transceiver in a tracking target; and
means for paging the installed cellular transceiver, over a cellular network control channel, to enter into a tracking mode to identify, from information provided through the RRES, one or more cell sites located near the tracking target so as to enable the tracking of the tracking target.

10. The system according to claim 9, further includes a chase vehicle deployed to a tracked location to enable the interception of a stolen vehicle, the chase vehicle including a tracking module having:
a Doppler direction finder for finding the direction of the stolen vehicle's cellular transceiver;
a tracking radio linked to the Doppler direction finder; and
an updating radio set to periodically update the chase vehicle's position in one direction, and update the control channel frequency, used by the tracking mode and tuned into the tracker module, in the other direction.

11. The system according to claim 10, wherein the chase vehicle is further equipped with a Global Positioning System (GPS) receiver for determining its own location with respect to one or more cell sites identified as being close to the target to enable the chase vehicle to more quickly travel to an area determined by the identified cell sites.

12. The system according to claim 9, further comprising means for using a determined unusable control channel to transmit tracking information so as to further minimize drain on cellular network resources.

13. A storage medium readable by a computer, the medium encoding a computer process to provide a tracking method employing cellular network control channels, leveraging existing Roamer Record Exchange Systems (RRES), the computer process comprising:
a processing portion for installing a cellular transceiver in a tracking target; and
a processing portion for paging the installed cellular transceiver, over a cellular network control channel, to enter into a tracking mode to identify, from information provided through the RRES, one or more cell sites located near the tracking target so as to enable the tracking of the tracking target.

14. The method according to claim 13, further includes a chase vehicle deployed to a tracked location to enable the interception of a stolen vehicle, the chase vehicle including a tracking module having:
a Doppler direction finder for finding the direction of the stolen vehicle's cellular transceiver;
a tracking radio linked to the Doppler direction finder; and
an updating radio set to periodically update the chase vehicle's position in one direction, and update the control channel frequency, used by the tracking mode and tuned into the tracker module, in the other direction.

15. The method according to claim 14, wherein the chase vehicle is further equipped with a Global Positioning System (GPS) receiver for determining its own location with respect to one or more cell sites identified as being close to the target to enable the chase vehicle to more quickly travel to an area determined by the identified cell sites.

16. The method according to claim 13, further comprising means for using a determined unusable control channel to transmit tracking information so as to further minimize drain on cellular network resources.
